(19) United States
(12) Patent Application Publication
(10) Pub. No.: US 2010/0333005 A1
(43) Pub. Date: Dec. 30, 2010

(54) Display Processing Apparatus, Display Processing Method, and Computer Program Product

(76) Inventors: Sayoko Tanaka, Tokyo (JP); Yoshihisa Kizuka, Tokyo (JP); Hitoshi Saijo, Tokyo (JP); Mieko Onodera, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/709,176

(22) Filed: Feb. 19, 2010

(30) Foreign Application Priority Data
Jun. 29, 2009 (JP) 2009-153898

(51) Int. Cl. G06F 3/14

(52) U.S. Cl. 715/767; 715/802

(57) ABSTRACT

According to one embodiment, an display processing apparatus includes an operation receiver, a relation calculator, a grouping module, a display information generator, and a display controller. The operation receiver receives operation to select key content. The relation calculator calculates the relation of second contents to the key content. The grouping module performs grouping of the second contents into a plurality of groups based on items related to the calculation of the relation and calculates the relation of the groups to the key content. The display information generator generates first display information of the key content and second display information of the second contents. The display controller displays list information in which pieces of the second display information of the second contents divided into the groups are arranged around the first display information such that a group with higher group relation is closer to the first display information.

### CROSS-REFERENCE TO RELATED APPLICATIONS

This application is based upon and claims the benefit of priority from Japanese Patent Application No. 2009-153898, filed on Jun. 29, 2009, the entire contents of which are incorporated herein by reference.

### BACKGROUND

1. Field

One embodiment of the invention relates to a display processing apparatus, a display processing method, and a computer program product.

2. Description of the Related Art

In recent years, with increased capability of AV equipment for storing contents and improved seamless accessibility of contents between equipment, let alone within the same equipment, or on a network, there has been a proliferation in the number of contents accessible to users. Accordingly, for example, Japanese Patent Application Publication (KOKAI) No. 2001-292383 discloses a conventional receiving device that allows users to select and view such contents.

With the conventional receiving device, in response to user selection of content from a list of contents, the content desired by the user is displayed. When the content selected by the user is stored in the device, the content is read and displayed on its data display module. On the other hand, when the content is present outside the device, the content is received from the outside and displayed on the data display module.

Besides, a recent increase in the capacity of storage media such as hard disk drive (HDD) provided to AV equipment increases video audio data (contents) stored in the storage media. This increases steps to retrieve video audio data (contents) that a user desires to view. If what is to be displayed includes video audio data (contents) on a network, then, the number of search objects further increases.

Thus, there is a need for a technology that facilitates the retrieval of video audio data (content) desired by a user from various types of contents.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a display processing apparatus according to a first embodiment of the invention;

FIG. 2 is an exemplary schematic diagram of metadata when a television (TV) program is content in the first embodiment;

FIG. 3A is an exemplary schematic diagram of display information indicating the details of content in the first embodiment;

FIG. 3B is another exemplary schematic diagram of display information indicating the details of content in the first embodiment;

FIG. 4A is an exemplary schematic diagram for explaining the operation of displaying the display information in the first embodiment;

FIG. 4B is another exemplary schematic diagram for explaining the operation of displaying the display information in the first embodiment;

FIG. 5 is still another exemplary schematic diagram for explaining the operation of displaying the display information in the first embodiment;

FIG. 6 is still another exemplary schematic diagram for explaining the operation of displaying the display information in the first embodiment;

FIG. 7 is still another exemplary schematic diagram for explaining the operation of displaying the display information in the first embodiment;

FIG. 8 is still another exemplary schematic diagram for explaining the operation of displaying the display information in the first embodiment;

FIG. 9 is an exemplary schematic diagram of list information in which are arranged display information of key content and that of other contents in first display mode in the first embodiment;

FIG. 10 is an exemplary flowchart of the process of displaying the display information in the first display mode performed by the display processing apparatus in the first embodiment;

FIG. 11 is an exemplary schematic diagram of list information in which are arranged display information of key content and that of other contents in second display mode in the first embodiment;

FIG. 12 is an exemplary flowchart of the process of displaying the display information in the second display mode performed by the display processing apparatus in the first embodiment;

FIG. 13 is an exemplary schematic diagram of list information according to a second embodiment of the invention;

FIG. 14 is an exemplary schematic diagram of the list information in which part of group range information is not displayed in the second embodiment;

FIG. 15A is an exemplary schematic diagram of standard display information according to a third embodiment of the invention;

FIG. 15B is an exemplary schematic diagram of detailed display information in the third embodiment;

FIG. 16 is an exemplary schematic diagram of standard list information in the third embodiment;

FIG. 17 is an exemplary schematic diagram for explaining zoom-in display in the third embodiment; and

FIG. 18 is an exemplary schematic diagram for explaining zoom-out display in the third embodiment.

### DETAILED DESCRIPTION

Various embodiments according to the invention will be described hereinafter with reference to the accompanying drawings. In general, according to one embodiment of the invention, a display processing apparatus comprises an operation receiver, a relation calculator, a grouping module, a display information generator, and a display controller. The operation receiver is configured to receive operation to select key content of a first type as a search key. The relation calculator is configured to calculate the relation of each of second contents to the key content as content relation. The second contents are of a plurality of types including a second type different from the first type. The grouping module is configured to perform grouping of the second contents into a plurality of groups based on items related to the calculation of the content relation and calculate the relation of each of the groups to the key content as group relation. The display information generator is configured to generate first display information of the key content and second display information of each of the second contents. The display controller is configured to display, on a display device, list information in which pieces of the second display information of the second contents divided into the groups are arranged around the first display information such that a group with higher group relation is closer to the first display information.

According to another embodiment of the invention, a computer program product comprises a computer usable medium having computer readable program codes embodied in the medium that, when executed, causes a computer to implement the above display processing apparatus.

According to still another embodiment of the invention, there is provided a display processing method applied to a display processing apparatus comprising a controller and a storage module. The display processing method is performed by the controller and comprises: an operation receiver receiving operation to select key content of a first type as a search key; a relation calculator calculating the relation of each of second contents to the key content as content relation, the second contents being of a plurality of types including a second type different from the first type; a grouping module performing grouping of the second contents into a plurality of groups based on items related to the calculation of the content relation and calculate the relation of each of the groups to the key content as group relation; a display information generator generating first display information of the key content and second display information of each of the second contents; and a display controller displaying, on a display device, list information in which pieces of the second display information of the second contents divided into the groups are arranged around the first display information such that a group with higher group relation is closer to the first display information.

Although a display processing apparatus of the embodiments is described below as being applied to a personal computer with a television (TV), this is by way of example only and is not to be construed to be limiting. The display processing apparatus may be applied to any display device capable of displaying video or the like. Briefly, in the following embodiments, when a user retrieves a key content as a search key and content related to the key content from a plurality of contents, the display processing apparatus displays the key content with contents related to the key content in response to user selection of the key content.

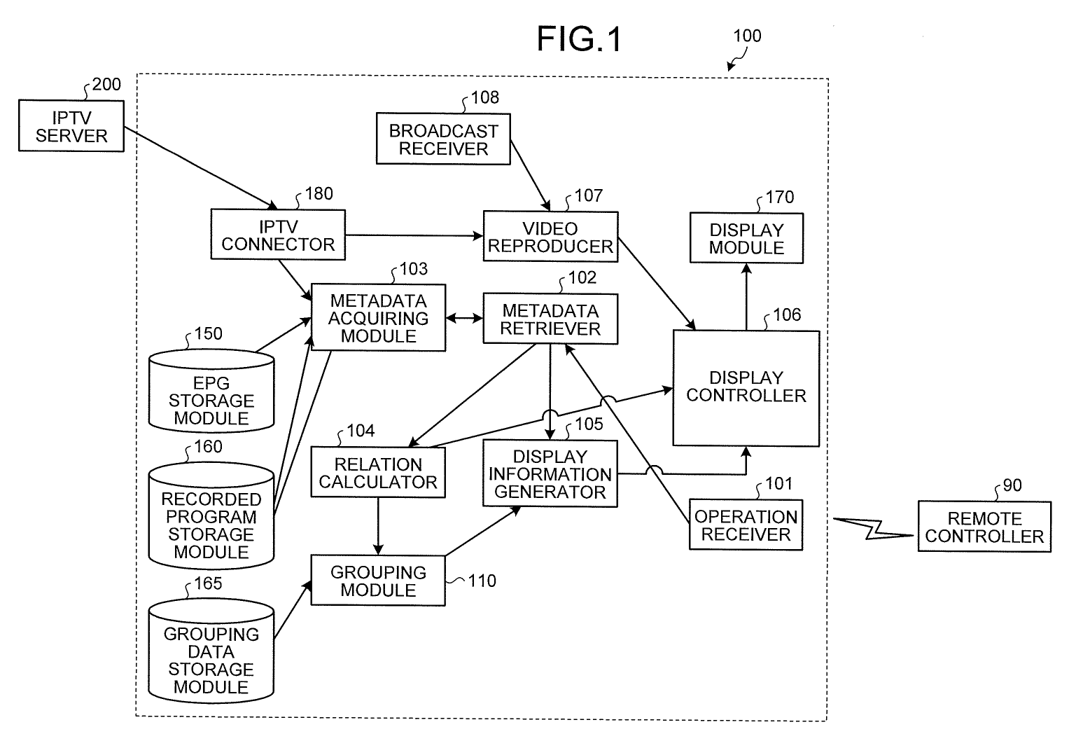

A first embodiment of the invention will now be described with reference to FIGS. 1 to 18. First, a description will be given of the functional configuration of a display processing apparatus 100 according to the first embodiment. FIG. 1 is a block diagram of the display processing apparatus 100. As illustrated in FIG. 1, the display processing apparatus 100 comprises an electronic program guide (EPG) storage module 150, a recorded program storage module 160, a grouping data storage module 165, a display module 170, a broadcast receiver 108, and an Internet protocol television (IPTV) connector 180. The display processing apparatus 100 is connected to an IPTV server 200 via a network. Although not illustrated in the drawings, the display processing apparatus 100 further comprises a processor, such as an application-specific integrated circuit (ASIC) or a central processing unit (CPU), and a storage device. Examples of the storage device include a read only memory (ROM) that stores a predetermined computer program for controlling the display processing apparatus 100 and a random access memory (RAM) that provides a work area for the processor. The cooperation of the processor and the computer program stored in the storage device implements functional modules including the EPG storage module 150, the recorded program storage module 160, the grouping data storage module 165, an operation receiver 101, a metadata retriever 102, a metadata acquiring module 103, a relation calculator 104, a display information generator 105, a display controller 106, a video reproducer 107, and a grouping module 110.

The IPTV server 200 provides services to distribute video such as TV programs and movies using IP. In response to a request from the display processing apparatus 100, the IPTV server 200 delivers thereto content such as the video and metadata of the content.

The IPTV connector 180 is an interface that connects between the display processing apparatus 100 and the IPTV server 200.

The EPG storage module 150 is a storage medium such as a hard disk drive (HDD) or a memory for storing an electronic program guide obtained from an external server that manages and distributes the electronic program guide. More specifically, the EPG storage module 150 obtains via a communication module (not illustrated) an electronic program guide for TV, cable television (CATV), communications satellite (CS) broadcasting, broadcasting satellite (BS) broadcasting, and the like from a service provider server connected through a network such as the Internet. Thus, the EPG storage module 150 stores the electronic program guide. It is assumed herein that the electronic program guide contains information on programs to be broadcasted during a period from the present time to a certain time in the future (e.g., after one week).

The recorded program storage module 160 is a storage medium such as HDD or memory for storing content such as video. For example, if the display processing apparatus 100 is TV with HDD, the recorded program storage module 160 stores video of a recorded TV program as the content. Examples of the content include video in a digital versatile disk (DVD) and video captured by a video camera.

The recorded program storage module 160 also stores metadata related to the content in association therewith. The term “metadata” as used herein refers to a set of information indicating unique characteristics of the content. The unique characteristics include the title of the content and the broadcast date and time of the content. For example, if the content is a TV program, the metadata indicates information (program information) on the TV program such as the title, the channel/broadcast date and time, the cast, the brief description (subtitle), and the genre. This metadata is provided to the recorded program storage module 160 with the content and stored therein in association with the content.

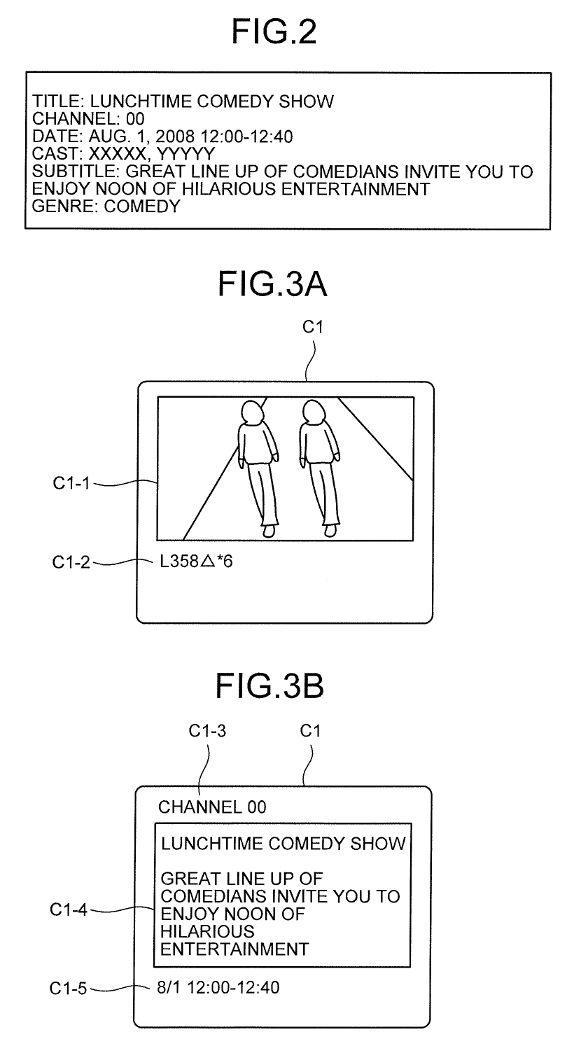

FIG. 2 illustrates the metadata when a TV program is the content. The metadata illustrated in FIG. 2 represents information related to the content of a recorded TV program. The recorded program storage module 160 stores as metadata the information, such as the title of the TV program “Lunchtime Comedy Show”, the channel “00”, the broadcast date and time “Aug. 1, 2008, 12:00-12:40”, the cast “xxxxx, yyyyy”, the subtitle “Great line up of comedians invite you to enjoy a noon of hilarious entertainment”, and the genre “comedy”.

Although an example is described above in which the metadata is provided as being preset, this is by way of example and not of limitation. The recorded program storage module 160 may receive information provided by a user thorough an input device such as a remote controller 90 and store it as metadata in association with the content.

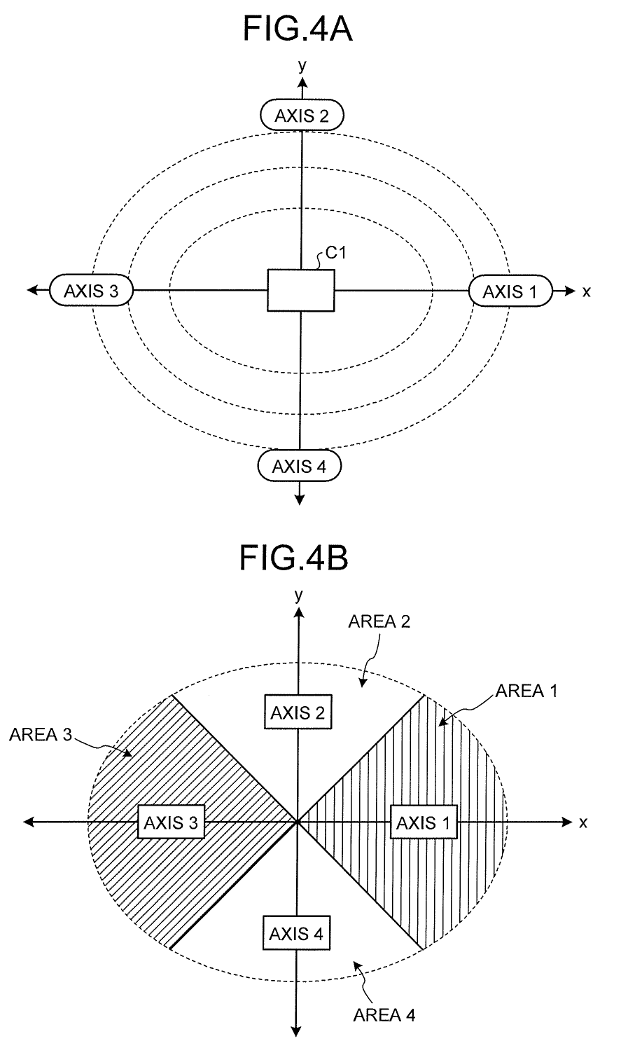

The display module 170 includes, for example, a liquid crystal display (LCD) for displaying text and an image, and displays content of a received TV program, stored content, an electronic program guide, and the like. The display module 170 also displays display information representing the details of content generated by the display information generator 105, which will be described later, to allow a user to retrieve the content (see FIGS. 4A to 4D).

The broadcast receiver 108 receives the content of video (TV program) broadcasted by TV broadcasting through an antenna or a cable (not illustrated).

The video reproducer 107 acquires the content of video that a user desires to reproduce. Examples of the content include the content of a TV program, etc. received by the broadcast receiver 108, the content of video acquired from the IPTV server 200 through the IPTV connector 180, and the content of video stored in the recorded program storage module 160. The video reproducer 107 decodes (reproduces) the content thus acquired, and outputs it to the display controller 106.

The operation receiver 101 receives user's operation. More specifically, when a user operates an input device, the operation receiver 101 recognizes the operation and receives an input provided by the operation. Examples of the input device include the remote controller 90 provided with operation buttons, a keyboard (not illustrated), and a mouse (not illustrated). The user's operation may be pressing an operation button on the remote controller 90, typing on the keyboard, moving the mouse or pressing the mouse button, and the like. For example, when a user retrieves desired content as well as contents related to the desired content from a plurality of contents, the user selects content (key content) as a search key using the input device from a plurality of contents of the electronic program guide displayed on the display module 170. The operation receiver 101 receives this selection of the key content. The key content may be content being reproduced. In this case, when a user operates the input device while content is being reproduced, the operation receiver 101 receives the user's operation as a selection of the key content, i.e., an instruction to retrieve contents. As will be described in detail later, the operation receiver 101 receives an instruction as to display information of focused content in list information displayed on the display module 170. The list information indicates pieces of display information of a plurality of contents.

The metadata acquiring module 103 acquires, when the operation receiver 101 receives selection operation for key content, meta data of all contents (the key content and other contents than the key content). More specifically, for example, the metadata acquiring module 103 acquires the metadata of the contents from the recorded program storage module 160. The metadata acquiring module 103 may request the IPTV server 200 for the metadata of the contents and acquire the metadata. The metadata acquiring module 103 may also acquire the metadata of the contents from the electronic program guide stored in the EPG storage module 150.

The metadata retriever 102 retrieves, when the operation receiver 101 receives selection operation for the key content, metadata of the key content from the metadata of the contents acquired by the metadata acquiring module 103. The metadata retriever 102 then outputs the metadata of the key content to the relation calculator 104. The metadata retriever 102 also retrieves, based on the metadata of the key content acquired from the metadata acquiring module 103, metadata of other contents to be the objects of calculation by the relation calculator 104 as to the relation to the metadata of the key content. The metadata retriever 102 then outputs the metadata of the other contents to the relation calculator 104.

The metadata retriever 102 also outputs, when the operation receiver 101 receives selection operation for the key content, the metadata of all the contents acquired by the metadata acquiring module 103 to the display information generator 105.

The relation calculator 104 calculates content relation, i.e., the relation of each of the other contents to the key content, based on the metadata of the key content and the metadata of the other contents received from the metadata retriever 102 for each item contained in the metadata. Examples of the item include title and channel. More specifically, the relation calculator 104 calculates content relation RM using the following Equation 1:

RM=Σₙ₋₁^{N} faₙ(M11(n), M21(n))×waₙ (1)

where N represents the total number of metadata items acquirable by the metadata acquiring module 103, M11 represents the metadata of the key content, M21 represents the metadata of any of the other contents, and (n) represents n-th metadata acquired by the metadata acquiring module 103. Further, faₙ(M11(n), M21(n)) is a function that returns the relation between metadata M11(n) and M21(n) as RMₙ, and Waₙ is a value (n=1, . . . , N) indicating weight.

As described above, although various types of information is acquired as the metadata, the metadata will be described below as including a set of five items (N=5), i.e., recoding date and time, title of content, channel, genre, and cast, for simplicity. The five items of the metadata will be described as n=1, 2, . . . , 5 in the above order.

The content relation RM of the other contents with respect to the key content can be represented by the weighted linear sum of the following five relations RM₁ to RM₅:

RM₁=fa₁ (recoding date and time of metadata M11, recoding date and time of metadata M21)

RM₂=fa₂ (title of metadata M11, title of metadata M21)

RM₃=fa₃ (channel of metadata M11, channel of metadata M21)

RM₄=fa₄ (genre of metadata M11, genre of metadata M21)

RM₅=fa₅ (cast of metadata M11, cast of metadata M21)

For example, fa₁ is a function that is larger for a smaller difference in recoding date and time between the metadata M11 and m21 and is smaller for a larger difference in the recoding date and time. More specifically, fa₁ may be represented by using a relational expression as follows:

MO1/|rec_data(M11)−rec_data(M21)|

where rec_data (x) is a function that uniquely converts recoding date and time of x into an integer, MO1 is an arbitrary constant number, and |X| is a function indicating the size of X and is typically an absolute value. Specifically, rec_data (x) is a function that converts the recoding date and time into an integer such as seconds having elapsed from a reference date and time determined as 0.

While an example is described above in which a function g represented as g (x)=MO1/|X| is applied to fa₁ (M11, M21)=g(rec_data (M11)−rec_data (M21)), it is not so limited. The function g may be a function with L2 norm as, for example, g(x)=MO1/∥x∥. In this case, ∥x∥ is the square root of the sum of squares of the differences between elements that constitute x.

Other functions such as a sigmoid function and a gamma function may be applied to g(x). Besides, while an example is described above in which the function is larger as the recoding dates and times of the metadata M11 and M21 are closer, it is not so limited. The function may be smaller as the recoding dates and times of the metadata M11 and M21 are closer. Further, the function g may be large when a specific condition is satisfied.

For example, fa₂ is a function that is larger as more of the same letters or characters are contained in the character strings of the titles of the respective metadata M11 and M21. More specifically, if the title of the metadata M11 is “ABCDE” and that of the metadata M11 is “FGCDH”, two letters “CD” are contained in both the titles. If the title of the metadata M11 is “ABCDE” and that of the metadata M11 is “FGHIE”, one letter is contained in both the titles. Therefore, the value of fa₂ is larger in the former case. The relation may be determined based on a keyword contained in the brief description (subtitle) of a program in the same manner as the title basis.

While an example is cited above in which the number of the same letters or characters contained in both the titles are simply compared, this is not intended as a limitation. Additional conditions may be used such as that the function is larger as more of the same letters or characters are contained in both the titles from the top, or that even if no same letter is present in both the titles, when the titles have a common idea, they are determined to be the same. As an example of the latter case, a Japanese word “yakyu” is regarded as the same as “baseball”, and the titles that contain the words “yakyu” and “baseball”, respectively, are determined to contain the same character string.

Besides, when the titles have the same main character string and different sub character strings, they are likely to be of contents of the same series. Accordingly, in such a case, the value of fa₂ may be set to large. Specifically, for example, “ABCDE #2” and “ABCDE #3” are likely to be the titles of different episodes of the same drama series. Therefore, in such a case, the value of fa₂ may be doubled. Note that the above is described by way of example only, and the comparison as described above may be accomplished with high accuracy by commonly known technologies such as approximate pattern matching and regular expression matching.

For example, fa₃ is a function that is large when the metadata M11 and M21 are of contents of the same channel. Simply, fa₃ may be a function that takes value MO2 when the metadata M11 and M21 are of contents of the same channel and otherwise takes value 0. The value MO2 is an arbitrary constant number. In addition, if the metadata M11 and M21 are of contents of affiliate channels, the value of fa₃ may be set to a different value. For example, fa₃ may be a function that returns value MO2/2 when the metadata M11 and M21 are of contents of affiliate channels. Further, fa₃ may be a function that returns value MO2/4 if the metadata M11 and M21 are of contents of affiliate channels but of different broadcast media. Note that the above is described by way of example only, and fa₃ may be an arbitrary function.

For example, fa₄ is a function that is large when the metadata M11 and M21 are of contents of the same genre. More specifically, fa₄ may be a function that takes value MO3 if the metadata M11 and M21 both belong to the same genre “sports” and otherwise takes value 0. In addition, if the metadata M21 belongs to the subgenre of the metadata M11 such as, for example, if the metadata M11 belongs to the genre “sports” and the metadata M21 belongs to the genre “baseball”, fa₄ may be a function that takes value MO3/2. Further, even if the metadata M11 and M21 do not directly belong to the same genre, when they can be categorized in the same genre such as, for example, when the metadata M11 belongs to the genre “baseball” while the metadata M21 belongs to the genre “football” and the both are categorized in sports, fa₄ may be a function that takes value MO3/4. Note that the above is described by way of example only, and fa₄ may be an arbitrary function.

For example, fa₅ is a similar function to fa₄. More specifically, if the metadata M11 is of the content featuring “WW, XX, YY” and the metadata M21 is of the content featuring “XX, YY, ZZ”, then the same two persons are casted for both the contents. In such a case, fa₅ may be a function that takes value 2×MO4 (MO4: an arbitrary constant number), and it may be a function that takes value 0 if there is no same person casted for both the contents. Besides, the cast may include a group or a member of a group. For example, if a person KK is a member of a group XX, and when the metadata M11 is of the content featuring “VV, WW, XX” and the metadata M21 is of the content featuring “KK, YY, ZZ”, the person KK is casted in the content of M11 as a member of the group XX and also is casted in the content of M21. In such a case, fa₅ may be a function that returns value MO4/2.

In a similar fashion, the relation between groups or between people featured in the contents may be defined. For example, when the groups XX and YY belong to the same office, fa₅ may be a function that returns value MO4/4. In this case, the relation between a person and a group or between a person, a group and an office may be defined in the metadata or may be obtained from an external server (information site).

While an example is described above in which the relation is calculated not differentiating people in the cast list, this is not so limited. The relation may further be weighted according to the order on the cast list. For example, the derived relation is left as it is with respect to the first person on the cast list for the metadata M11, while it is weighted by ½ with respect to the second person and similarly is weighted by ⅓ with respect to the third person. The order on the cast list for the metadata M21 may also be taken into account in addition to that for the metadata M11. For example, if the second person on the cast list for the metadata M11 is the third person on the cast list for the metadata M21, the relation may be weighted by ½ with respect to the second person for the metadata M11 and may further be weighted by ⅓ with respect to the third person for the metadata M21. That is, the relation may be weighted by ½×⅓=⅙. Besides, the relation may be weighted differently with respect to a star playing a leading role based on information on the cast or the like. For example, the derived relation may be double-weighted with respect to the star.

The display information generator 105 generates display information representing the details of the key content and the other contents based on the metadata of the key content and that of the other contents output from the metadata retriever 102. More specifically, for example, based on the metadata of content of video data stored in the recorded program storage module 160, the display information generator 105 adds such items as a title to the representative image of the video data to generate display information to be displayed on the display module 170. Further, for example, based on the metadata of content of video data obtained from the IPTV server 200, the display information generator 105 adds such items as a title to the representative image of the video data to generate display information to be displayed on the display module 170. Still further, for example, based on the electronic program guide stored in the EPG storage module 150, the display information generator 105 generates display information to be displayed on the display module 170 to indicate the title of a TV program, the broadcast date and time, the channel, the brief description (subtitle) of the TV program, and the like.

The display information will now be described in detail. FIGS. 3A and 3B illustrate examples of the display information representing the details of content. FIG. 3A illustrates display information C1 of the key content generated based on, for example, the metadata of video data stored in the recorded program storage module 160. As illustrated in FIG. 3A, the display information C1 includes a representative image C1-1 of the content and title “L358Δ*6” C1-2 of the content (video). On the other hand, FIG. 3B illustrates the display information C1 of the key content generated based on, for example, the electronic program guide. As illustrated in FIG. 3B, the display information C1 includes the channel C1-3, title “Lunchtime Comedy Show” with subtitle “Great line up of comedians invite you to enjoy a noon of hilarious entertainment” C1-4 of the content (video), and broadcast date and time C1-5.

The display controller 106 displays content output from the video reproducer 107 on the display module 170.

As described above, when the operation receiver 101 receives an instruction from a user to retrieve content, the display controller 106 displays list information indicating a list of display information of key content and that of other contents related to the key content on the display module 170 to allow the user to retrieve the content. The display processing apparatus 100 is provided with two display modes, i.e., first display mode and second display mode, to display the list information. The first and the second display modes are switched by a user through the input device.

The first display mode will be described first. In the list information of the first display mode, the display information of the key content is arranged in a desired position. With the position of the display information of the key content as the center, pieces of the display information of the other contents are arranged to form concentric polygons, for example, correspondingly to the directions of operation on an operation button such as an arrow key on the remote controller 90 or the keyboard. The screen is divided into predetermined areas for respective items in radial directions from the center. The pieces of the display information of the other contents are arranged in the predetermined areas such that the one with higher content relation is closer to the center. Additionally, in the list information, the display information of the key content is displayed in the largest size, and the display information of the other contents is displayed smaller as the distance from the center increases. A description will be given of the operation of displaying the display information. FIGS. 4A to 8 are schematic diagrams for explaining the operation of displaying the display information.

As illustrated in FIG. 4A, the display controller 106 arranges display information C1 of the key content at a desired position. The display controller 106 then sets, using the position of the display information C1 as the center, four axes (axes 1 to 4) in the positive x-axis direction, the positive y-axis direction, the negative x-axis direction, and the negative y-axis direction, respectively. Thereafter, the display controller 106 assigns each item contained in the metadata of the selected key content to one of the four axes. Referring to FIG. 2, as items contained in the metadata, the “title” of a TV program (content), the “cast” of the TV program, a “keyword” for search contained in the brief description of the TV program, and the “genre” of the TV program are each assigned to one of the four axes. A user can use the items assigned to the axes as indices for searching for contents related to the key content.

As illustrated in FIG. 4B, the display controller 106 divides the display area into predetermined areas (areas 1 to 4) in radial directions from the display information C1 in the center. The display area is divided at an arbitrary angle, for example, an angle of 90°, such that each of the predetermined areas includes one of the axes assigned one of the items. In this manner, the display controller 106 generates the predetermined areas (area 1 to 4) each including one of the axes.

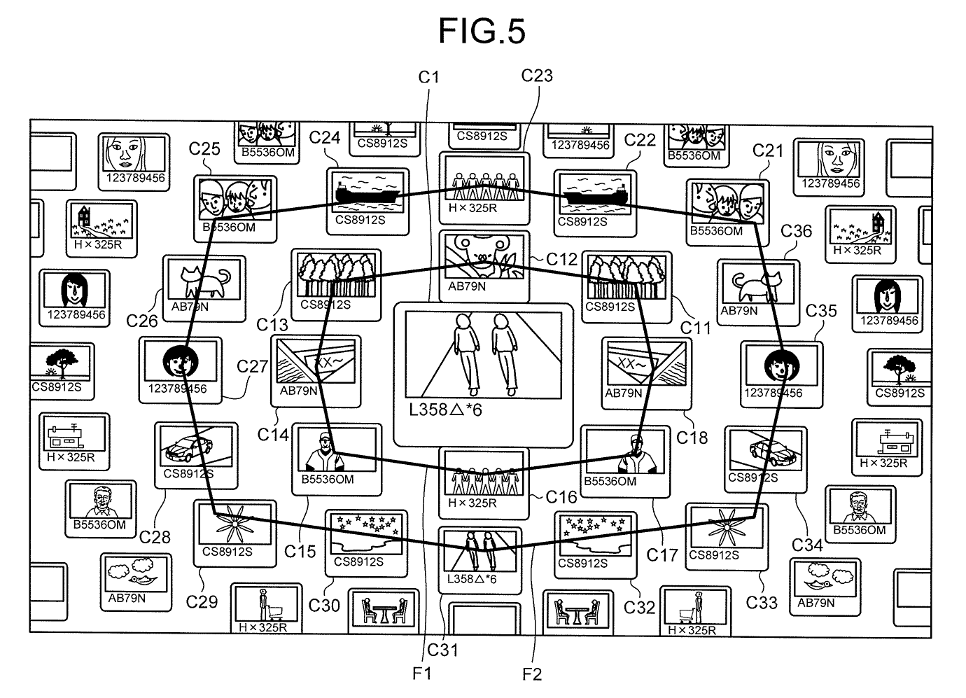

As illustrated in FIG. 5, the display controller 106 arranges pieces of display information of other contents on a plurality of octagons F1, F2, . . . , which are concentrically formed around the display information C1 of the key content as the center, correspondingly to up, down, left, and right directions of the operation button on the remote controller 90 or the keyboard. More specifically, the display controller 106 arranges eight pieces of display information C11 to C18 of other contents on the corners of the octagon F1. Further, the display controller 106 arranges on the corners of the octagon F2 eight pieces of display information C21, C23, C25, C27, C29, C31, C33, and C35 of other contents, and also eight pieces of display information C22, C24, C26, C28, C30, C32, C34, and C36 of other contents between the respective pieces along the directions of operation. In the same manner as just described, the display controller 106 arranges on the corners of each octagon eight pieces of display information of other contents, and also eight pieces of display information of other contents between the respective pieces. With this arrangement of display information of other contents, with respect to any piece of display information, other pieces of display information are arranged along the up, down, left, or right directions of operation.

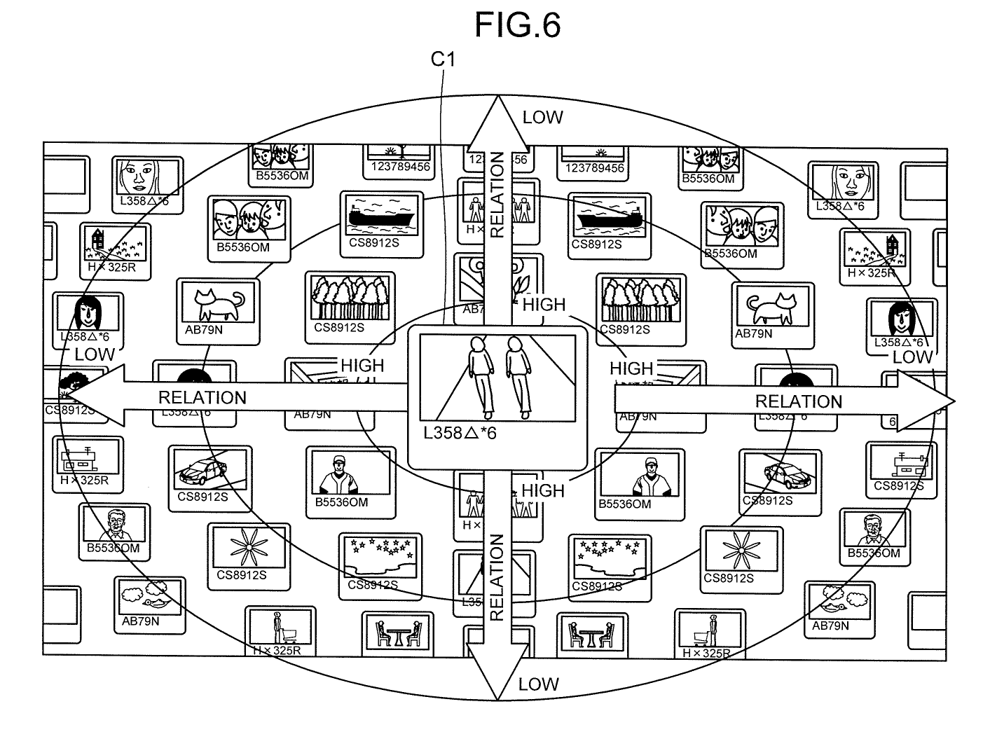

At this time, as illustrated in FIG. 6, the display controller 106 arranges pieces of display information of other contents with higher content relation to the key content closer to the center at which is arranged the display information 01 of the key content. In other words, pieces of display information of other contents with lower content relation to the key content are arranged more distant from the center. That is, in the example of FIG. 5, the display controller 106 arranges pieces of display information of other contents with the highest content relation to the key content on the octagon F1. The display controller 106 also arranges pieces of display information of other contents in descending order of content relation to the key content on the octagon F2, and other octagons (not illustrated).

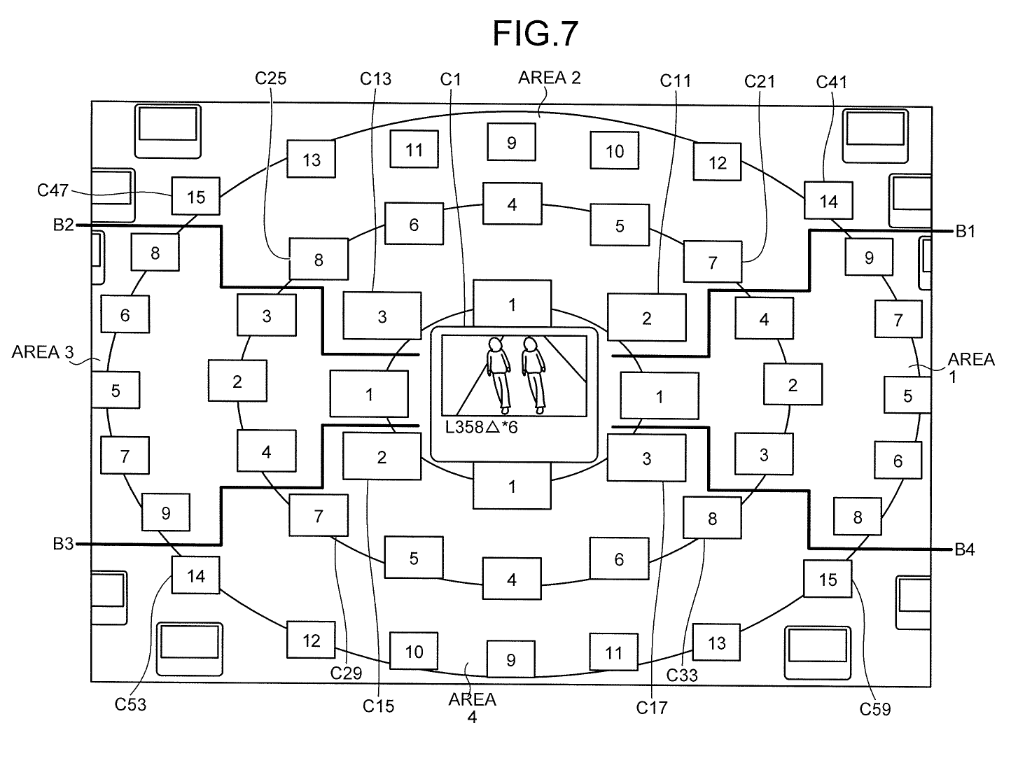

In addition, the display controller 106 arranges pieces of display information of other contents in descending order of content relation to the key content in each of the predetermined areas previously obtained for each item. That is, the display controller 106 classifies the display information of other contents by the items assigned to the areas (axes), respectively. More specifically, as illustrated in FIG. 7, for respective items assigned to the area 1 defined by boundary lines B1 and B4, the area 2 defined by boundary lines B1 and B2, the area 3 defined by boundary lines B2 and B3, and the area 4 defined by boundary lines B3 and B4, the display controller 106 arranges pieces of display information of other contents in the order of numbers assigned to the pieces in FIG. 7. Thus, with respect to each of the items, the pieces of the display information of the other contents can be arranged from around the center in descending order of content relation to the key content.

In the example of FIG. 7, pieces of the display information C11, C21 and C41 are located in positions capable of belonging to both the areas 1 and 2. For example, the pieces of the display information C11, C21 and C41 may be set to belong to either one of the areas or items in which more contents with content relation to the key content higher than a predetermined threshold are present than in the other. In FIG. 7, since more other contents with content relation higher than the predetermined threshold are present in the area 2 than in the area 1, the pieces of the display information C11, C21 and C41 belong to the area 2. The same is applied to pieces of the display information C13, C25, C47, C15, C29, C53, C17, C33, and C59.

While an area to which display information displayed near a boundary line belongs is described above as being determined based on the degree of content relation to the key content, this is by way of example and not of limitation. For example, display information displayed near a boundary line may belong to an area having more contents related to the key content than the other.

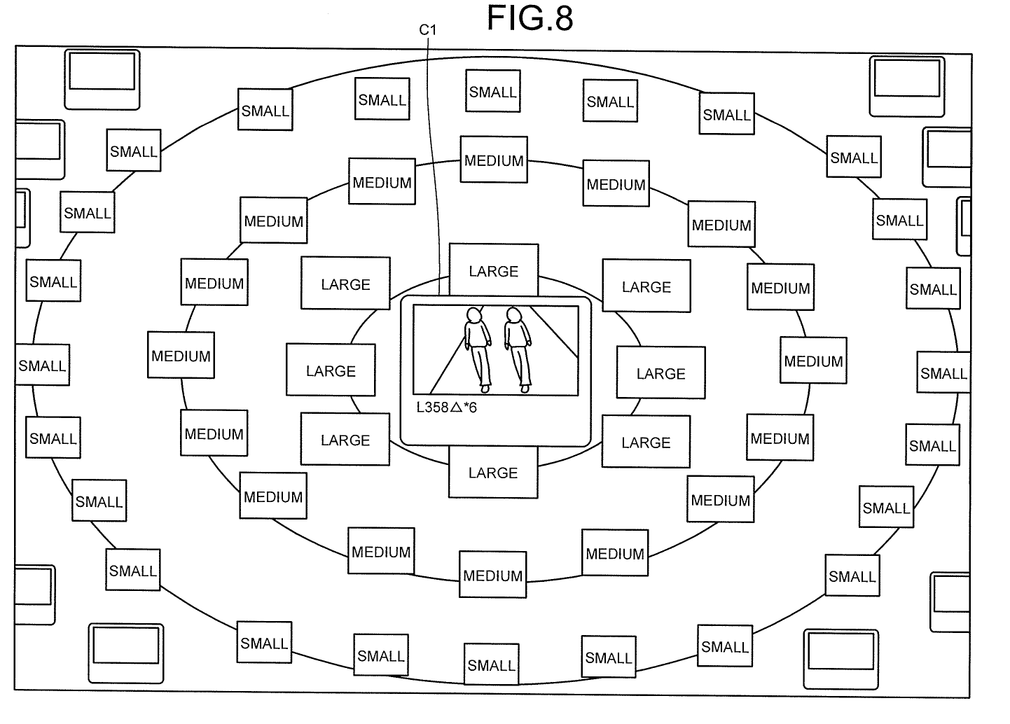

Further, as illustrated in FIG. 8, the display controller 106 displays the display information of the key content in the largest size, and the display information of the other contents smaller as the distance from the center increases.

When display information of another content than the key content belongs to a plurality of areas, the display controller 106 displays the display information in one of the areas so that the same display information is not displayed concurrently in the different areas. More specifically, when display information of the other content belongs to the areas 1 and 2, the display information is displayed in only one area assigned an item with respect to which the other content has higher content relation to the key content.

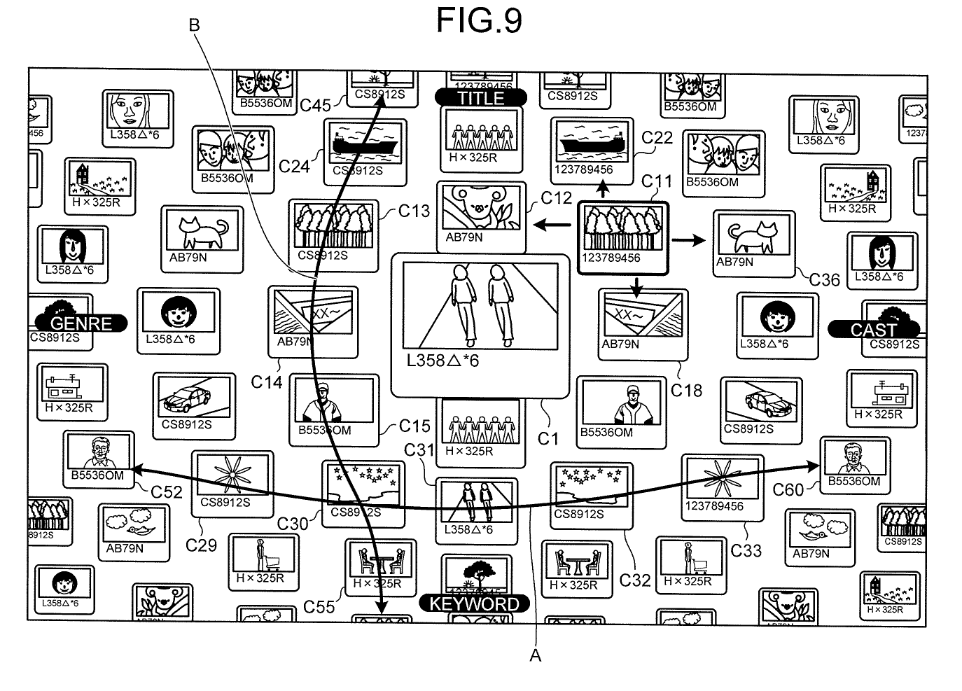

In this manner, the display controller 106 generates list information in which are arranged the display information C1 of the key content and the display information C11, . . . of the other contents, and displays the list information on the display module 170. Incidentally, the display controller 106 stores in advance the display position and size of the display information, and, after the calculation of the content relation to the key content, sequentially arranges pieces of the display information of the other contents each in a predetermined size. FIG. 9 illustrates an example of the list information in which are arranged the display information C1 of the key content and the standard mode display information C11, . . . of the other contents in the first display mode. In the list information of FIG. 9, items “Title”, “Cast”, “Keyword”, and “Genre” are displayed on the upside, right side, downside, and left side of the screen, respectively. Further, with the display information C1 of the key content as the center, pieces of the display information of the other contents are arranged from around the center toward the outside.

As described above, according to the first embodiment, pieces of display information of other contents than key content are arranged along up, down, left, and right directions of operation. Therefore, in the example of FIG. 9, if the display information C30 is focused content for search, upon receipt of an instruction for left-right movement through the operation button on the remote controller 90 or the keyboard, the focus on the display information C30 moves in directions indicated by a double-head arrow A. Similarly, if the display information C30 is focused content for search, upon receipt of an instruction for up-down movement through the operation button, the focus on the display information C30 moves in directions indicated by a double-head arrow B. Additionally, for example, if the cursor moves one space to the right in response to an instruction when the focus is on the display information C11, the focus moves to the display information C36. Similarly, if the cursor moves one space in the up, left, or down direction in response to an instruction, the focus moves from the display information C11 to the display information C22, C12, or C18. Thus, the operation using the operation button such as an arrow key on the remote controller 90 or the keyboard can be facilitated.

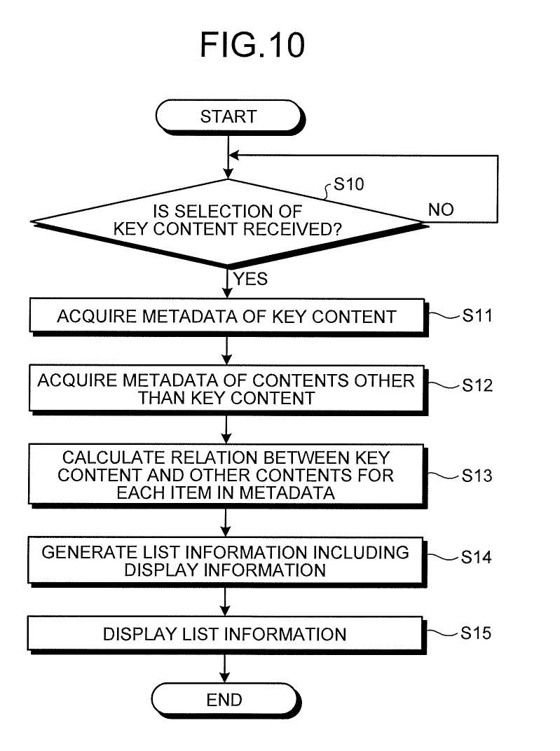

A description will now be given of the process of displaying display information in the first display mode performed by the display processing apparatus 100. FIG. 10 is a flowchart of the process of displaying the display information in the first display mode performed by the display processing apparatus 100.

The operation receiver 101 waits for receiving the selection of key content thorough the input device (S10). Upon receipt of the selection (Yes at S10), the metadata acquiring module 103 acquires metadata of the selected key content (S11). The metadata acquiring module 103 then acquires metadata of contents other than the key content (S12).

The relation calculator 104 calculates the content relation of each of the other contents to the key content with respect to each item contained in the metadata (S13). The display controller 106 generates list information in which are arranged display information of the key content and display information of the other contents (S14). Pieces of the display information of the other contents are arranged according to their content relation to the key content. The display controller 106 displays the list information on the display module 170 (S15).

As described above, the list information is displayed in which are arranged display information of key content as a search key and that of other contents related to the key content. In the list information, with the position of the display information of the key content as the center, pieces of the display information of the other contents are arranged to form concentric polygons along the directions of operation with the operation button on the remote controller or the keyboard. Pieces of display information of other contents with higher relation to the key content are arranged closer to the center. With this, by operating the remote controller 90, the keyboard, or the like, a user can easily retrieve content related to the key content from various types of contents.

The second display mode will be described next. The second display mode is similar to the first display mode in that the content relation of each of other contents to key content is calculated, and the other contents are classified into a plurality of areas each assigned an item. On the other hand, the second display mode is different from the first display mode in that the other contents are grouped to be displayed. The second display mode is implemented by the processing of the grouping module 110 and the grouping data storage module 165.

The grouping data storage module 165 stores a word value (importance) with respect to each word. The word value is set in advance and represented by a numeral. The higher the word value, the more important the word is. Taking words “sports” and “baseball” as an example, the word value of “baseball” is set higher than that of “sports”.

The grouping module 110 divides a plurality of types of other contents than key content into a plurality of groups based on the items related to the calculation of the content relation. More specifically, the grouping module 110 specifies a reference item (first related keyword) with respect to each of the other contents from the metadata of the other content as a reference for grouping, and makes groups each formed of other contents having the same reference item. The grouping module 110 specifies the most important one of words contained in the metadata of the other content and used to calculate the content relation as the reference item. At this time, the grouping module 110 refers to the grouping data storage module 165 to acquire the word value of each word, and compares the word values of words to determine the most important word.

According to the second embodiment, the grouping module 110 performs the grouping with respect to each item assigned to each divisional area (each item assigned to each of the axes 1 to 4). More specifically, after the relation calculator 104 calculates the content relation of each of other contents to key content, the grouping module 110 groups or classifies the other contents with respect to each item assigned to each divisional area (each item assigned to each of the axes). The grouping is basically similar to the process performed by the display controller 106 in the first display mode except that the result is not displayed. The grouping module 110 specifies a reference item from words belonging to each item assigned to each divisional area. For example, with respect to the item “genre”, the grouping module 110 compares the word values of words “sports”, baseball”, “football”, etc. related to the “genre” as candidates of a reference item, and determines the most important word as the reference item. The grouping module 110 divides other contents than key content into groups each including contents with the same reference item. Thus, the grouping module 110 generates a plurality of groups such as a group with the reference item “football”, a group with the reference item “baseball”, and the like.

Besides, the grouping module 110 calculates the relation of each group (group relation) to key content. The group relation is calculated with respect to each item assigned to each divisional area (each item assigned to each of the axes). To calculate the group relation, the grouping module 110 obtains higher content relation to key content in each of groups, and ranks the groups in descending order of the content relation. The grouping module 110 sets this order as the group relation. In this case, a higher order group has higher group relation. Alternatively, for example, the grouping module 110 obtains the group relation by ranking the groups in descending order of the sum of content relations of all contents in each group to the key content. The grouping module 110 sets this order as the group relation. In this case, also, a higher order group has higher group relation. The grouping module 110 may obtain the group relation by ranking the groups in descending order of the number of contents in each group and set this order as the group relation. In this case, also, a higher order group has higher group relation.

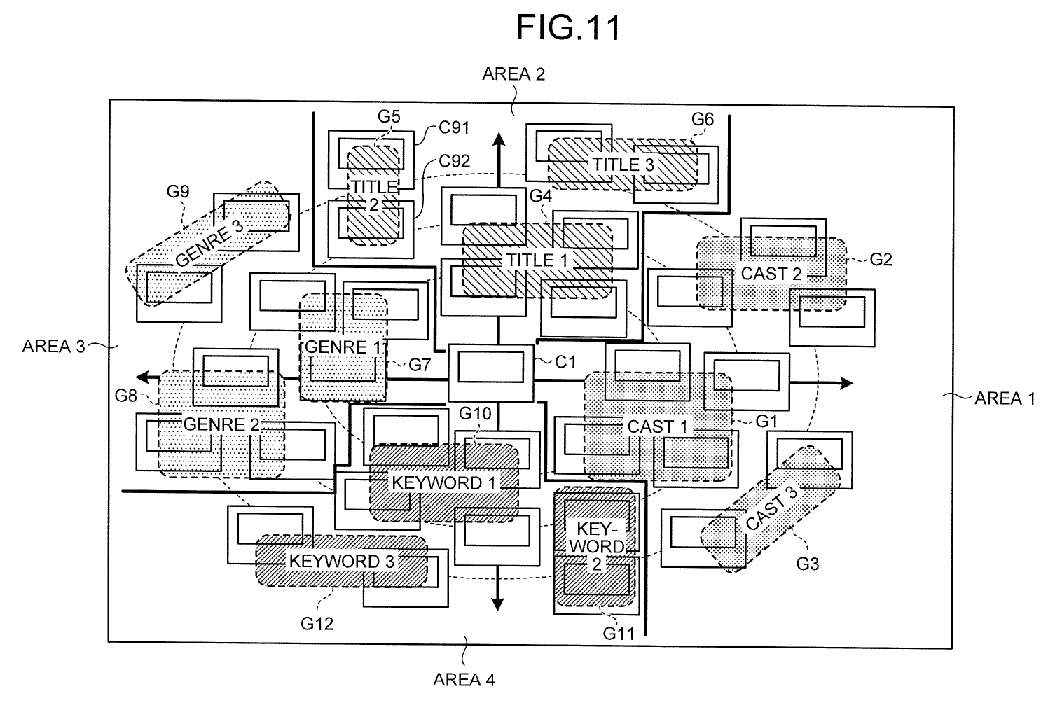

With reference to FIG. 11, a detailed description will be given of the operation of displaying display information in the second display mode. FIG. 11 is a schematic diagram of list information in which are arranged display information of key content and that of other contents in the second display mode.

The second display mode is similar to the first display mode in, for example, that the display area is divided into predetermined areas each including one of the axes (the areas 1 to 4, see FIG. 4B), and pieces of display information of other contents are arranged in the predetermined areas. Hereinafter, the difference from the first display mode will be described.

In the second display mode, as illustrated in FIG. 11, the display controller 106 displays on the display module 170 list information in which groups G1 to G12 of display information (C91, C92, etc.) of other contents are arranged around the display information C1 of key content. At this time, the display controller 106 arranges the display information (C91, C92, etc.) of the other contents in the areas 1 to 4 obtained by dividing the display area for respective items in radial directions from the display information C1 of the key content as the center, each in corresponding one of the areas 1 to 4. In the example of FIG. 11, three groups G1 to G3 related to cast 1 to 3 are displayed in the area 1. Similarly, three groups G4 to G6 related to title 1 to 3, G7 to G9 related to genre 1 to 3, and G10 to G12 related to keyword 1 to 3 are displayed in the areas 2 to 4, respectively. In FIG. 11, areas of the groups G1 to G12 are indicated by virtual lines, and the groups G1 to G12 are accompanied with their names (cast 1, title 1, etc.) for the sake of convenience of illustration, these are not displayed in practice.

Besides, the display controller 106 arranges the groups G1 to G12 such that the one with higher group relation is closer to the position of the display information C1 of the key content. That is, the list information of the second display mode includes display information of key content and pieces of display information of other contents divided into groups around the display information of the key content. A group with higher group relation is closer to the position of the display information of the key content. In the example of FIG. 11, in the area 2, the group relation becomes higher in the order of the group G6 of the title 6, the group G5 of the title 2, and the group G4 of the title 1. Accordingly, the group G4 of the title 1, the group G5 of the title 2, and the group G6 of the title 6 are arranged closer to the display information C1 of the key content in this order. The distance between each of the groups G1 to G12 and the display information C1 of the key content may be determined based on the shortest distance therebetween, the distance between the center of display information of another content closest to the display information C1 in the groups G1 to G12 and the center of the display information C1, or the like.

Besides, the display controller 106 arranges pieces of display information of the other contents such that the one with higher content relation is closer to the display information Cl of the key content in the groups G1 to G12. For example, in FIG. 11, in the group G5 of the title 2, the content relation of content corresponding to display information C92 is higher than that of content corresponding to display information C91. Thus, the display information C92 is located closer to the display information 01 of the key content than the display information C91.

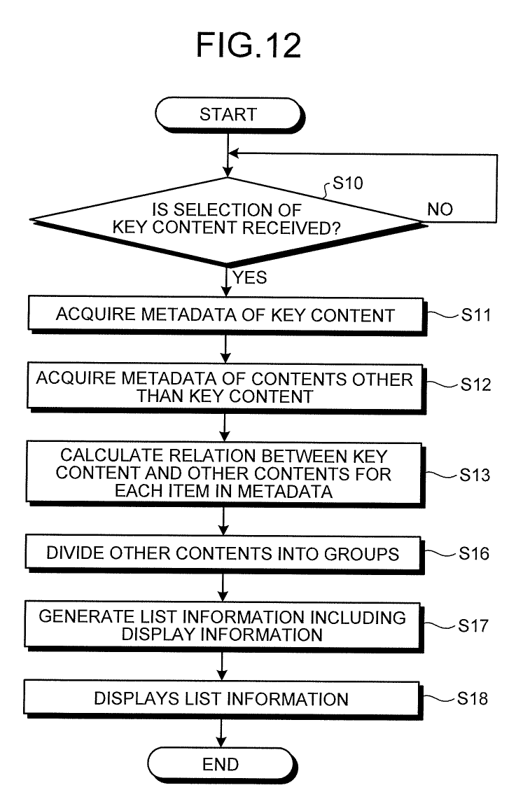

A description will now be given of the process of displaying display information in the second display mode performed by the display processing apparatus 100. FIG. 12 is a flowchart of the process of displaying the display information in the second display mode performed by the display processing apparatus 100.

The display processing apparatus 100 performs the process from S10 to S13 in the same manner as in the first display mode, and then the process moves to S16. The grouping module 110 divides a plurality of types of other contents than key content into a plurality of groups based on the items related to the calculation of the content relation, and calculates the group relation to the key content (S16).

The display controller 106 generates list information in which are arranged display information of the key content and display information of the other contents (S17). Pieces of the display information of the other contents divided into the groups are arranged around the display information of the key content. The display controller 106 displays the list information on the display module 170 (S18).

Further, the display controller 106 comprises a scrolling module (not illustrated) and has the following functions. When the operation receiver 101 receives an instruction to specify display information of focused content through the input device, the scrolling module scrolls the list information in the operation direction in a predetermined display range. At this time, regardless of the movement amount of the list information due to scrolling by the scrolling module, the display controller 106 maintains display information of key content to be displayed in the display range. Besides, the display controller 106 displays the display information of the focused content specified from other contents than the key content by the operation with the input device in such a manner that the display information of the focused content is larger than that of the other contents not specified.

As described above, according to the first embodiment, the display processing apparatus 100 comprises the display controller 106 that displays list information, in which pieces of display information of other contents than key content divided into groups are arranged around display information of the key content, on the display module 170. Thus, a user can easily retrieve content related to the key content from various contents by using the input device. In addition, if interested in a reference item, the user can refer to all contents having the reference item with less operation.

Moreover, according to the first embodiment, the display controller 106 arranges the groups such that the one with higher group relation is closer to the position of the display information of the key content. This further facilitates the retrieval of content related to the key content from various contents.

Furthermore, according to the first embodiment, the display controller 106 arranges the pieces of display information of the other contents such that the one with higher content relation is closer to the display information of the key content in each of the groups. This further facilitates the retrieval of content related to the key content from various contents.

The computer program (hereinafter, “display processing program”) may be executed on a computer to realize the same function as the display processing apparatus 100. The display processing program may be provided to the computer as being stored in a computer-readable storage medium, such as a compact disc-read only memory (CD-ROM), a flexible disk (FD), a compact disc recordable (CD-R), and a digital versatile disc (DVD), as a file in an installable or executable format.

The display processing program may also be stored in a computer connected via a network such as the Internet so that it can be downloaded therefrom via the network. The display processing program may also be provide or distributed via a network such as the Internet.

The display processing program may also be provided as being stored in advance in ROM or the like. The display processing program comprises modules that implement the above constituent elements (the operation receiver 101, the metadata retriever 102, the metadata acquiring module 103, the relation calculator 104, the display information generator 105, the display controller 106, the video reproducer 107, the broadcast receiver 108, and the grouping module 110). As real hardware, the CPU (processor) loads the display processing program from the storage medium as described above into the main memory and executes it. With this, the constituent elements, such as the operation receiver 101, the metadata retriever 102, the metadata acquiring module 103, the relation calculator 104, the display information generator 105, the display controller 106, the video reproducer 107, the broadcast receiver 108, and the grouping module 110, may be implemented on the main memory.

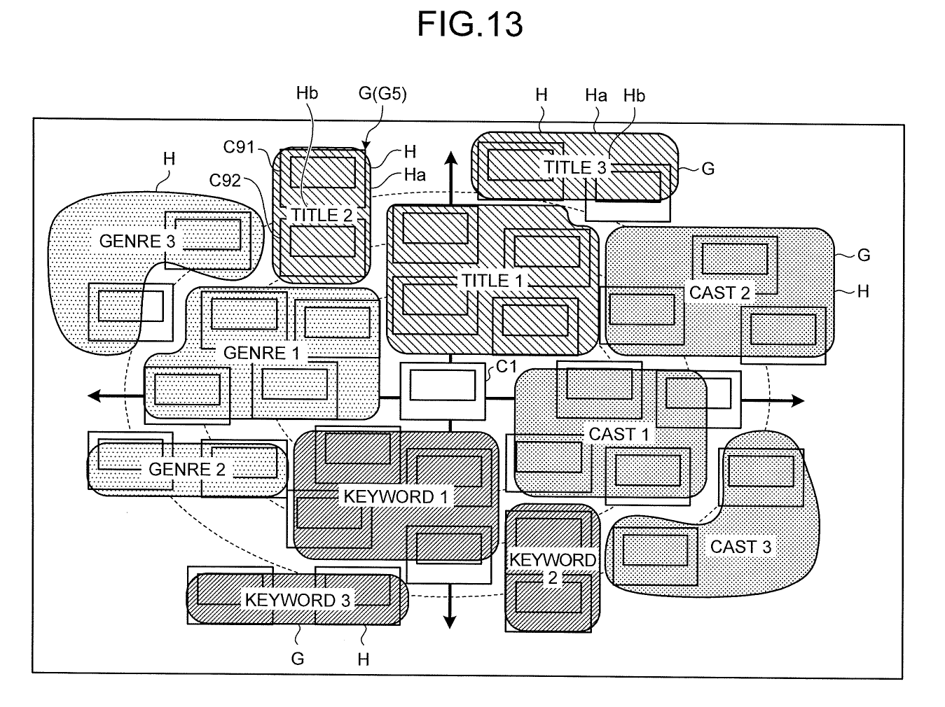

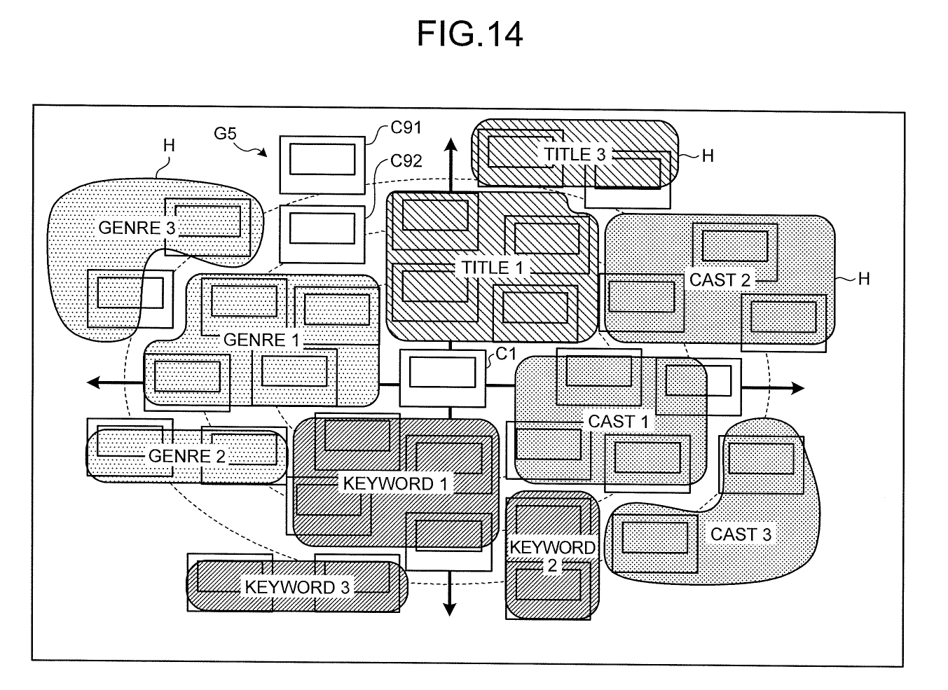

In the following, a second embodiment of the invention will be described with reference to FIGS. 13 and 14. Elements corresponding to those of the first embodiment are designated by the same reference numerals or characters, and their description will not be repeated.

The second embodiment is in many respects similar to the first embodiment except for the operation of the operation receiver 101, the display information generator 105, and the display controller 106. Incidentally, if it is not necessary to distinguish groups, the groups are denoted by G.

The display information generator 105 generates group range information indicating the range of a group.

The operation receiver 101 receives an instruction not to display the group range information indicating a group of contents. The instruction includes an instruction not to display the entire group range information and an instruction not to display specific part of the group range information.

As illustrated in FIG. 13, the display controller 106 displays list information including group range information H on the display module 170. In the example of FIG. 13, the group range information H includes area information Ha and a group name Hb. The area information Ha is overlaid on display information (for example, C91 and C92) of contents belonging to a group G and covers over the display information (for example, C91 and C92) of the contents. The group name Hb indicates a reference item of the group as the name of the group. The area information Ha is displayed as being overlaid on display information of content other than key content. Such a display of the group range information H overlaid on display information of content allows a user to recognize the details of display information of content. Besides, the area information Ha is displayed in a different color for each area (axis). When the group range information H is displayed, display information of other contents may not be displayed. This reduces information displayed on the display module 170 and simplifies the display.

When the operation receiver 101 receives an instruction not to display the entire group range information H, the display controller 106 does not display the entire group range information H (the state illustrated in FIG. 11).

When the operation receiver 101 receives an instruction not to display specific part of the group range information H, the display controller 106 does not display the specific part of the group range information H. In the example of FIG. 14, the content corresponding to the display information C91 is selected as focused content. Among a plurality of pieces of the group range information H, only the group range information H (see FIG. 13) corresponding to the group G5 of the title 2 containing the focused content (the content corresponding to the display information C91) is not displayed. In this manner, according to the second embodiment, the group range information H corresponding to a group including display information of focused content is not displayed, while other pieces of the group range information H are displayed. The display and non-display of the group range information H are switched in response to a change in focused content.

The display processing apparatus 100 configured as above operates basically in the same manner as previously described in connection with FIG. 12 to display the display information. At S17, the display information generator 105 generates group range information. At S18, the display controller 106 displays list information including the group range information on the display module 170.

As described above, according to the second embodiment, the display processing apparatus 100 displays group range information indicating the range of each group. Accordingly, a user can easily recognize the group and narrow down contents to retrieve. Thus, the user can easily retrieve content related to the key content from various types of contents.

Moreover, according to the second embodiment, the display processing apparatus 100 displays the group range information containing a reference item corresponding to the group. Thus, a user can easily recognize what the group is related to.

Furthermore, according to the second embodiment, upon receipt of an instruction not to display the group range information, the display processing apparatus 100 does not display the group range information. Thus, a user can recognize the details of contents in a group in which he/she is interested in. In this case, if the entire group range information is not displayed, the user is provided with the details of more contents. On the other hand, if specific part of the group range information is not displayed, the user is provided with only necessary information.

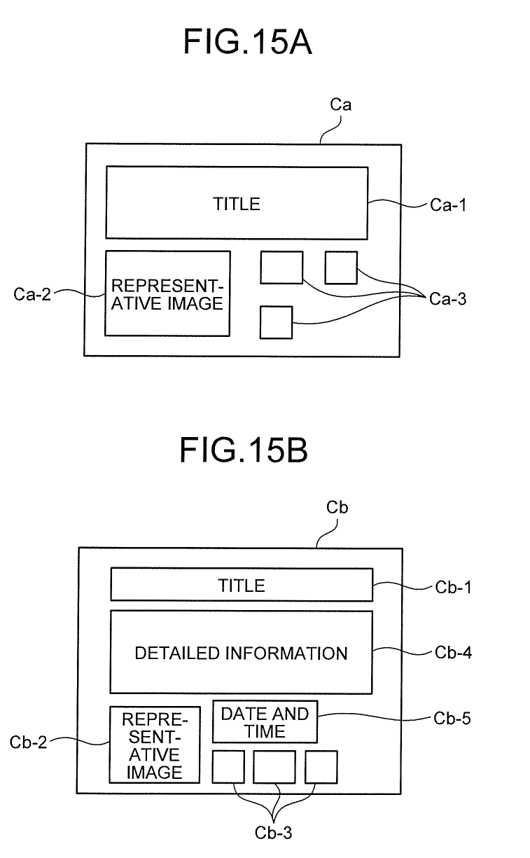

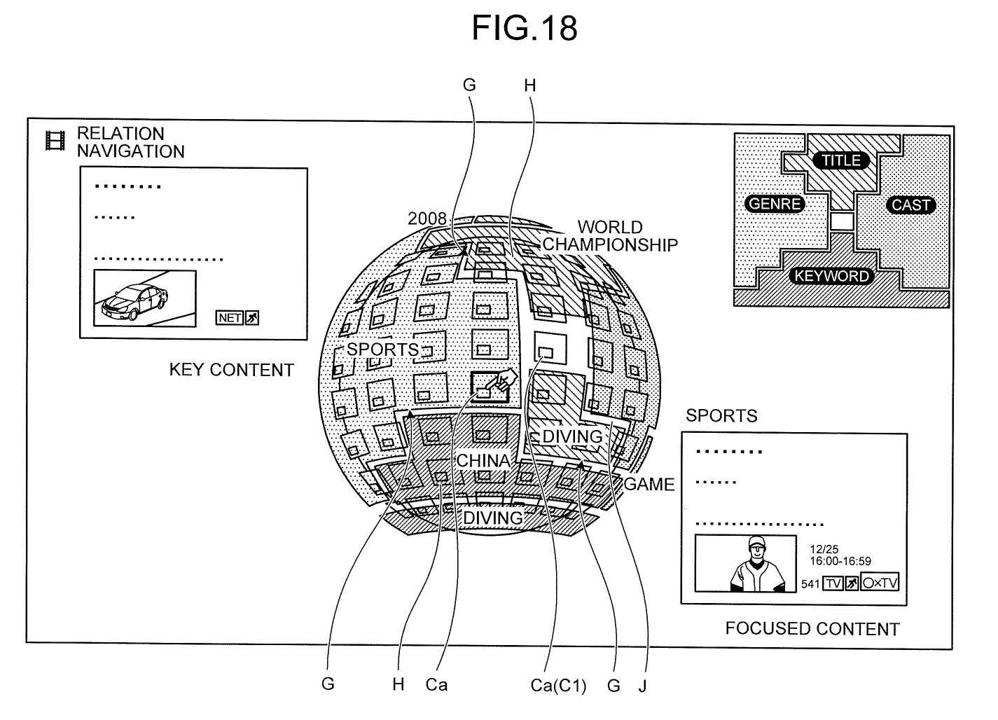

In the following, a third embodiment of the invention will be described with reference to FIGS. 15A and 18. Elements corresponding to those of the first and the second embodiments are designated by the same reference numerals or characters, and their description will not be repeated.

The third embodiment is in many respects similar to the second embodiment except that list information is displayed as if arranged on a virtual sphere and the display varies according to zoom operation.

The operation receiver 101 receives zoom-in operation and zoom-out operation from a user though the input device.

The display information generator 105 generates, as display information, standard display information and detailed display information containing more information than the standard display information. FIG. 15A illustrates an example of the standard display information. FIG. 15B illustrates an example of the detailed display information. In the following, display information of key content and that of other contents are not specifically distinguished, and the standard display information of content is denoted by Ca, while the detailed display information of content is denoted by Cb. As illustrated in FIG. 15A, standard display information Ca displays title Ca-1, a thumbnail view of a representative image Ca-2, and a plurality of icons Ca-3. The icons Ca-3 each indicate genre, broadcast station, or the like. On the other hand, detailed display information Cb displays, in addition to title Cb-1, a thumbnail view of a representative image Cb-2, and a plurality of icons Cb-3, detailed information Cb-4 and date and time Cb-5. The detailed information Cb-4 indicates the details of content by text. The date and time Cb-5 indicates the recording date and time or the broadcast date and time of the content. In the detailed display information Cb, the display areas of the detailed information Cb-4 and the date and time Cb-5 are secured by displaying the title Cb-1, the representative image Cb-2, and the icons Cb-3 smaller than the title Ca-1, the representative image Ca-2, and the icons Ca-3 of the corresponding standard display information Ca, respectively.

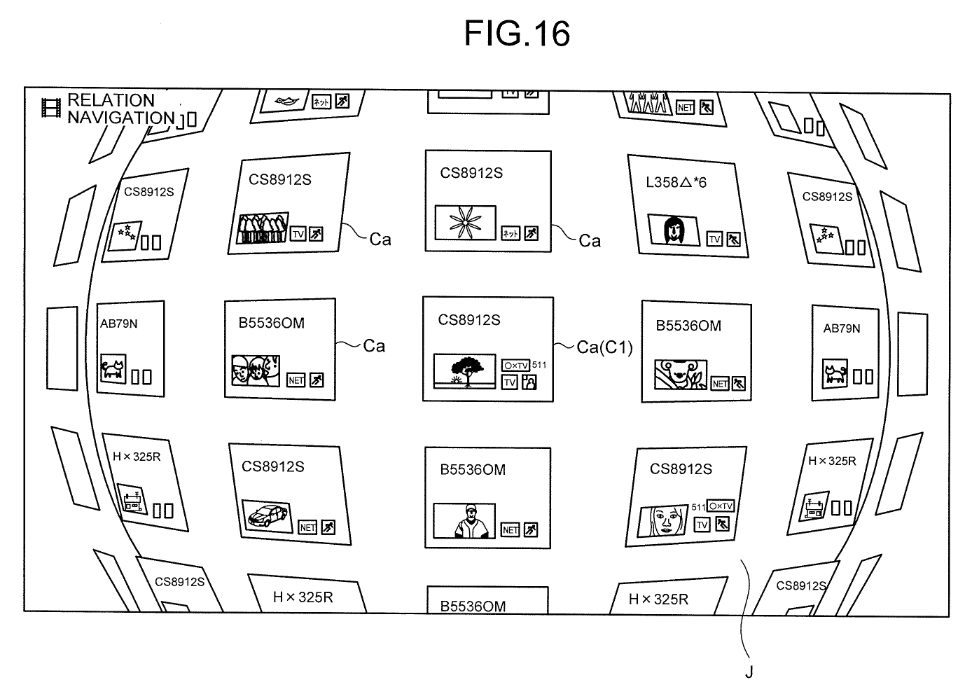

When the operation receiver 101 receives an instruction from a user to retrieve content and receives neither zoom-in operation nor zoom-out operation, the display controller 106 displays list information indicating a list of display information of key content and that of other contents related to the key content to allow the user to perform the retrieval. As illustrated in FIG. 16, the list information is displayed on the display module 170 as if arranged on a virtual sphere J. While pieces of display information of other contents are arranged to form concentric polygons around the position of display information of key content as the center in the first and the second embodiments, pieces of display information are arranged rectangularly in the third embodiment.

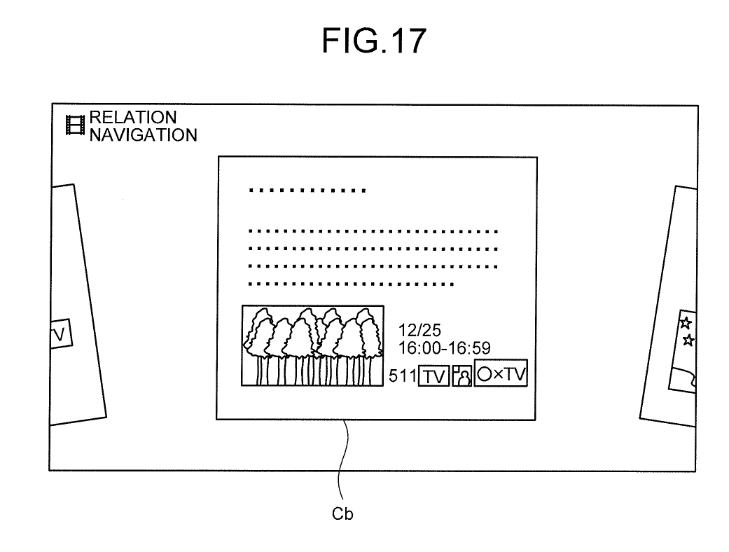

When the operation receiver 101 receives zoom-in operation, as illustrated in FIG. 17, the display controller 106 reduces other contents than key content in the standard list information, and provides zoom-in display using the detailed display information Cb as display information of content. In this case, according to the third embodiment, the detailed display information Cb of one content is displayed zoomed in. On the other hand, when the operation receiver 101 receives zoom-out operation, as illustrated in FIG. 18, the display controller 106 increases other contents than key content in the standard list information, and provides zoom-out display in which the group range information H is displayed on the virtual sphere J. In the zoom-out display, display information of the key content and that of focused content are displayed separately outside the area of the virtual sphere J.

As described above, according to the third embodiment, when receiving neither zoom-in operation nor zoom-out operation, the display processing apparatus 100 displays standard list information using standard display information. Upon receipt of zoom-in operation, the display processing apparatus 100 reduces other contents than key content in the standard list information, and provides zoom-in display using detailed display information. On the other hand, upon receipt of zoom-out operation, the display processing apparatus 100 increases other contents than key content in the standard list information, and provides zoom-out display in which group range information is displayed. Thus, according to zoom-in operation or zoom-out operation provided from a user, display information can be displayed differently in information amount and details.

Moreover, according to the third embodiment, the list information is arranged on a virtual sphere. This makes an impression as if the list information is arranged on, for example, a common globe. Thus, a user can instinctively provide operation.

While the reference item is described above as being determined word values stored in the grouping data storage module 165, it is not so limited. The reference item may be, for example, a word most contributing to content relation upon calculation of the content relation. Besides, information on focused content and key content may be displayed in a different area than the area of list information. Further, also in the first and the second embodiments, display information may be displayed differently in response to zoom-in operation or zoom-out operation as described in the third embodiment.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A display processing apparatus comprising:
an operation receiver configured to receive operation to select key content as a search key;
a relation calculator configured to calculate relation of each of a plurality of other contents to the key content as content relation, the other contents being different from the key content;
a grouping module configured to perform grouping of the other contents into a plurality of groups based on items related to calculation of the content relation and calculate relation of each of the groups to the key content as group relation;
a display information generator configured to generate pieces of display information indicating details of the key content and the other contents; and
a display controller configured to display, on a display device, list information in which pieces of the display information of the other contents divided into the groups are arranged around the display information of the key content such that a group with higher group relation is closer to the display information of the key content, and names of the groups are displayed.

2. The display processing apparatus of claim 1, wherein the display controller is configured to display the pieces of the display information of the other contents such that display information of other content with higher content relation is closer to the display information of the key content in the groups.

3. The display processing apparatus of claim 1, further comprising a metadata acquiring module configured to acquire metadata of the key content and metadata of each of the other contents, wherein
the relation calculator is configured to calculate the content relation based on the metadata of the key content and the metadata of the other contents, and
the grouping module is configured to specify a reference item as a reference for the grouping from the metadata of the other contents with respect to each of the other contents, and
each of the groups is formed of other contents corresponding to an identical reference item.

4. The display processing apparatus of claim 3, wherein the display controller is configured to display the list information divided into areas, each corresponding to one of the items, radially from the display information of the key content as a center, the pieces of the display information of the other contents each arranged in corresponding one of the areas.

5. The display processing apparatus of claim 1, wherein the display controller is configured to display group range information indicating a range of each of the groups.

6. The display processing apparatus of claim 3, wherein the display controller is configured to display group range information that indicates a range of each of the groups and contains the reference item corresponding to each of the groups.

7. The display processing apparatus of claim 5, wherein
the operation receiver is configured to receive operation not to display the group range information, and
when the operation receiver receives the operation not to display the group range information, the display controller does not display the group range information.

8. The display processing apparatus of claim 7, wherein, when the operation receiver receives the operation not to display the group range information, the display controller does not display the entire group range information.

9. The display processing apparatus of claim 7, wherein
the operation receiver is configured to receive operation not to display specific part of the group range information, and
when the operation receiver receives the operation not to display specific part of the group range information, the display controller does not display the specific part of the group range information.

10. The display processing apparatus of claim 5, wherein
the operation receiver is configured to receive zoom-in operation and zoom-out operation,
the display information generator is configured to generate, as the display information, standard display information and detailed display information containing more information than the standard display information,
when the operation receiver receives neither the zoom-in operation nor the zoom-out operation, the display controller displays standard list information as the list information based on the standard display information,
when the operation receiver receives the zoom-in operation, the display controller reduces the other contents in the standard list information, and provides zoom-in display based on the detailed display information, and
when the operation receiver receives the zoom-out operation, the display controller increases the other contents in the standard list information, and provides zoom-out display in which the group range information is displayed.

11. The display processing apparatus of claim 1, wherein the display controller is configured to display the list information on a virtual sphere.

12. A computer program product comprising a computer usable medium having computer readable program codes embodied in the medium that, when executed, causes a computer to implement:
an operation receiver configured to receive operation to select key content of a first type as a search key;
a relation calculator configured to calculate relation of each of a plurality of other contents to the key content as content relation, the other contents being different from the key content;
a grouping module configured to perform grouping of the other contents into a plurality of groups based on items related to calculation of the content relation and calculate relation of each of the groups to the key content as group relation;
a display information generator configured to generate pieces of display information indicating details of the key content and the other contents; and
a display controller configured to display, on a display device, list information in which pieces of the display information of the other contents divided into the groups are arranged around the display information of the key content such that a group with higher group relation is closer to the display information of the key content, and names of the groups are displayed.

13. A display processing method applied to a display processing apparatus comprising a controller and a storage module, the display processing method performed by the controller and comprising:
an operation receiver receiving operation to select key content as a search key;
a relation calculator calculating relation of each of a plurality of other contents to the key content as content relation, the other contents being different from the key content;
a grouping module performing grouping of the other contents into a plurality of groups based on items related to calculation of the content relation and calculate relation of each of the groups to the key content as group relation;
a display information generator generating pieces of display information indicating details of the key content and the other contents; and
a display controller displaying, on a display device, list information in which pieces of the display information of the other contents divided into the groups are arranged around the display information of the key content such that a group with higher group relation is closer to the display information of the key content, and names of the groups are displayed.
